(19) United States
(12) Patent Application Publication
(10) Pub. No.: US 2024/0119301 A1
(43) Pub. Date: Apr. 11, 2024

(54) NEURAL DIRECTED ACYCLIC GRAPH (DAG) SCHEDULING VIA ONE-SHOT PRIORITY SAMPLING

(71) Applicant: QUALCOMM Incorporated, San Diego, CA (US)

(72) Inventors: Wonseok JEON, San Diego, CA (US); Mukul GAGRANI, Milpitas, CA (US); Weiliang ZENG, San Diego, CA (US); Edward TEAGUE, San Diego, CA (US); Burak BARTAN, San Jose, CA (US); Piero ZAPPI, La Jolla, CA (US); Christopher LOTT, San Diego, CA (US)

(21) Appl. No.: 18/464,996

(22) Filed: Sep. 11, 2023

Related U.S. Application Data
(60) Provisional application No. 63/411,029, filed on Sep. 28, 2022.

(51) Int. Cl. G06N 3/092

(52) U.S. Cl. CPC G06N 3/092

(57) ABSTRACT

A processor-implemented method includes sampling, according to a priority sampling policy, a set of node priorities from a computation graph. Each node priority of the set of node priorities may be associated with a respective node on the computation graph. Additionally, each node may represent an operation of a task performed by an artificial neural network. The method also includes converting, via a list scheduling function, the node priorities to a schedule that associates each node of the computation graph with a processor of a group of processors of a device associated with the artificial neural network, the schedule associated with a makespan. The method further includes performing the task in accordance with the schedule.

### CROSS-REFERENCE TO RELATED APPLICATION

The present application claims the benefit of U.S. Provisional Patent Application No. 63/411,029, filed on Sep. 28, 2022, and titled “NEURAL DIRECTED ACYCLIC GRAPH (DAG) SCHEDULING VIA ONE-SHOT PRIORITY SAMPLING,” the disclosure of which is expressly incorporated by reference in its entirety.

### FIELD OF THE DISCLOSURE

Aspects of the present disclosure generally relate to machine learning, and more specifically to scheduling tasks to computing resources.

### BACKGROUND

Artificial neural networks may comprise interconnected groups of artificial neurons (e.g., neuron models). The artificial neural network may be a computational device or be represented as a method to be performed by a computational device.

In some cases, tasks may be divided into multiple operations, and these operations may be assigned to one or more device resources, such as processors, based on a schedule. The scheduler may outline an order and timing for executing each operation on a particular resource based on a priority of each operation. Different schedules can lead to variations in the time it takes to perform computations associated with these operations. This scheduling process may be used for operations associated with a task that may be performed by the artificial neural network. An object recognition task is an example of a task that may be performed by the artificial neural network.

### SUMMARY

In some aspects of the present disclosure, a processor-implemented method includes sampling, according to a priority sampling policy, a set of node priorities from a computation graph. Each node priority of the set of node priorities may be associated with a respective node on the computation graph. Additionally, each node may represent an operation of a task performed by an artificial neural network. The method also includes converting, via a list scheduling function, the node priorities to a schedule that associates each node of the computation graph with a processor of a group of processors of a device associated with the artificial neural network, the schedule associated with a makespan. The method further includes performing the task in accordance with the schedule.

Some other aspects of the present disclosure are directed to an apparatus including means for sampling, according to a priority sampling policy, a set of node priorities from a computation graph. Each node priority of the set of node priorities may be associated with a respective node on the computation graph. Additionally, each node may represent an operation of a task performed by an artificial neural network. The apparatus also includes means for converting, via a list scheduling function, the node priorities to a schedule that associates each node of the computation graph with a processor of a group of processors of a device associated with the artificial neural network, the schedule associated with a makespan. The apparatus further includes means for performing the task in accordance with the schedule.

In some other aspects of the present disclosure, a non-transitory computer-readable medium with non-transitory program code recorded thereon is disclosed. The program code is executed by one or more processors and includes program code to sample, according to a priority sampling policy, a set of node priorities from a computation graph. Each node priority of the set of node priorities may be associated with a respective node on the computation graph. Additionally, each node may represent an operation of a task performed by an artificial neural network. The program code also includes program code to convert, via a list scheduling function, the node priorities to a schedule that associates each node of the computation graph with a processor of a group of processors of a device associated with the artificial neural network, the schedule associated with a makespan. The program code further includes program code to perform the task in accordance with the schedule.

Some other aspects of the present disclosure are directed to an apparatus having one or more processors, and one or more memories coupled with the one or more processors and storing instructions operable, when executed by the one or more processors, to cause the apparatus to sample, according to a priority sampling policy, a set of node priorities from a computation graph. Each node priority of the set of node priorities may be associated with a respective node on the computation graph. Additionally, each node may represent an operation of a task performed by an artificial neural network. Execution of the instructions also cause the apparatus to convert, via a list scheduling function, the node priorities to a schedule that associates each node of the computation graph with a processor of a group of processors of a device associated with the artificial neural network, the schedule associated with a makespan. Execution of the instructions further cause the apparatus to perform the task in accordance with the schedule.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 3 is a diagram illustrating an example of a scheduling model associated with scheduling operations associated with a directed acyclic graph (DAG), in accordance with various aspects of the present disclosure.

FIG. 4 is a timing diagram illustrating an example of scheduling nodes in a DAG, in accordance with various aspects of the present disclosure.

FIG. 5 is a flow diagram illustrating an example of a process for scheduling operations, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some cases, tasks may be divided into multiple operations, and these operations may be assigned to one or more device resources, such as one or more processors, based on a schedule. An object recognition task is an example of a task performed by an artificial neural network. Aspects of the present disclosure are not limited to object recognition tasks, as other types of tasks are contemplated. Additionally, aspects of the present disclosure are not limited to tasks performed by an artificial neural network. A computational step, such as matrix multiplication, involved in training or executing a neural network may be an example of an operation. Such operations may be parallelized over multiple processors (e.g., processing devices) associated with one or more devices (e.g., hardware devices). To reduce a runtime associated with the task, a scheduler may schedule the execution of these operations based on a priority of each operation and in accordance with an availability of processing devices. Different schedules may lead to variations in the time it takes to perform computations associated with these operations.

In some conventional systems, heuristic algorithms are used to improve scheduling. In other conventional systems, machine learning schedulers have been used. However, conventional machine learning schedulers may be computationally expensive because these conventional machine learning schedulers rely on episodic reinforcement learning frameworks and require multiple rounds of neural network processing.

Various aspects of the present disclosure are directed to improving operation scheduling. In some examples, each operation may be associated with a node of a set of nodes. The set of nodes may be interconnected through a directed acyclic graph (DAG) that represents the dependencies associated with the nodes. In some examples, a machine learning scheduler is used for operation scheduling. In such examples, the machine learning scheduler uses a one-shot neural network encoder that samples node priorities in parallel. The sampled priorities may be converted into a final schedule using a list scheduling technique.

Particular aspects of the subject matter described in this disclosure can be implemented to realize one or more of the following potential advantages. In some examples, the combination of a one-shot neural network encoder with list scheduling reduces computational costs while improving overall network performance (e.g., speed and accuracy). As a result, aspects of the present disclosure improve the scheduling of operations, such as operations (e.g., nodes) characterized by DAG dependencies.

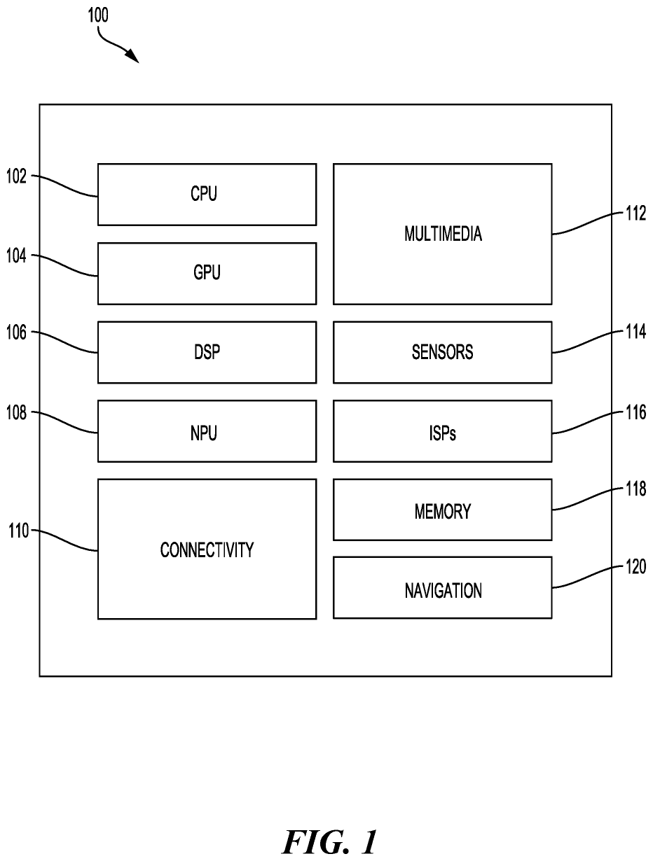

FIG. 1 illustrates an example implementation of a system-on-a-chip (SOC) 100, which may include a central processing unit (CPU) 102 or a multi-core CPU configured for DAG scheduling via one-shot sampling. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to sample, according to a priority sampling policy, a set of node priorities from a computation graph, each node priority from the set of priorities associated with a node on the computation graph, each node representing an operation of a task performed by an artificial neural network; convert the node priorities to a schedule via a list scheduling function, the schedule associated with a makespan, the schedule associating each node of the computation graph with a processor of a group of processors of a device implanting the artificial neural network; and perform the task based on the schedule.

Object recognition is an example of a task performed by an artificial neural network. In some examples, an object recognition task learns to represent inputs at successively higher levels of abstraction in each layer, thereby building up a useful feature representation of the input data.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

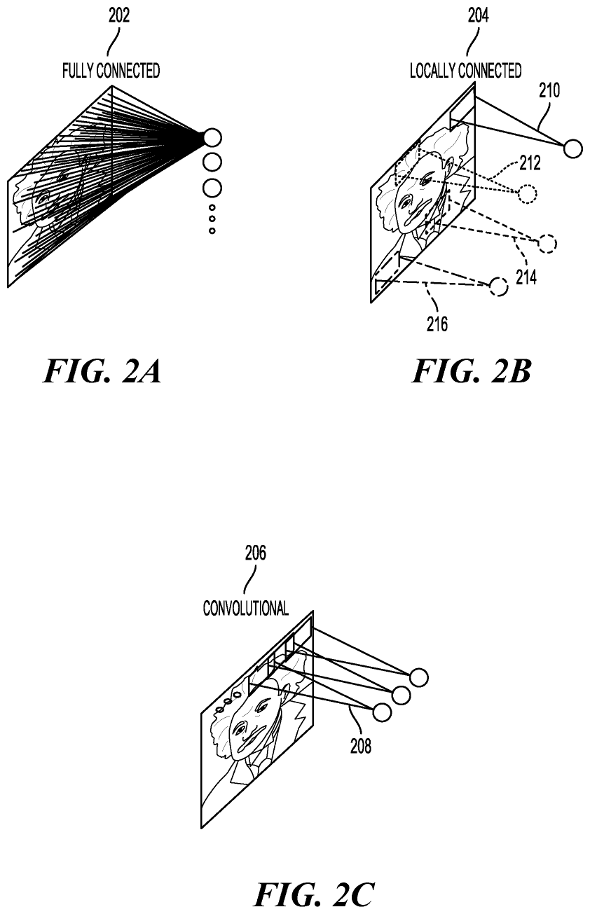

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

In some cases, tasks may be divided into multiple operations, and these operations may be assigned to various device resources, such as processors, based on a schedule. An object recognition task is one example of a task. A computational step, such as matrix multiplication, use for training or executing an artificial neural network may be an example of an operation. Such operations may be parallelized over multiple processors (e.g., processing devices) associated with one or more devices (e.g., hardware devices). A scheduler may schedule these operations on available processing devices to reduce a runtime associated with the task. Different schedules can lead to variations in the time it takes to perform computations associated with these operations. The scheduler may schedule the operations based on a priority of each operation.

Scheduling operations is a challenge in various domains, including (but not limited to) data centers, manufacturing pipelines, and compilers. For instance, in data centers, incoming jobs need to be efficiently scheduled on distributed servers. In manufacturing, job shop scheduling problems involve scheduling operations within a pipeline. Compilers also face the task of scheduling operations from a computation graph onto available hardware devices. In each of these examples, the scheduling problem can be represented as a directed acyclic graph (DAG), where nodes correspond to operations and edges represent dependency constraints between the operations. This type of scheduling problem may be referred to as a DAG scheduling problem. One objective for solving the DAG scheduling problem is to minimize an overall execution time (e.g., makespan) of the DAG while considering resource availability and dependency constraints. Various scheduling solutions may be specified to identify an arrangement of operations that minimizes the overall execution time, while ensuring operations are performed in the correct order based on the respective dependencies of the operations DAG.

The DAG scheduling problem may be considered a non-deterministic polynomial-time hard (NP-hard) problem. Some conventional systems use heuristic solutions to solve the DAG scheduling problem. List scheduling is an example of a heuristic solution, in which nodes are prioritized and scheduled in accordance with the priority. The priorities may be based on various node metrics, such as (but not limited to) critical-path, shortest processing time, or most operations remaining. Conventional list scheduling solutions may process multiple edges in a graph when prioritizing nodes. In conventional list scheduling solutions, multiple forward computations may be specified, thereby increasing resource use, such as processor and/or memory use.

Other conventional systems use deep reinforcement learning-based solutions to address the scheduling problem. These solutions may use graph neural networks (GNN) as encoders to derive node embeddings. Existing machine learning-based schedulers entail high computational costs due to the need for multi-round neural network processing during the encoding step. This drawback arises from the auto-regressive nature of schedulers. Consequently, these machine learning-based approaches face limitations in terms of scalability when operating with large graphs and their practical applicability in domains that specify timely solutions, such as scheduling operations in compilers for computation graphs.

It may be desirable to address the computational cost challenge and develop more efficient machine learning-based schedulers that can handle larger graphs and provide timely solutions. Overcoming the aforementioned limitations would expand the applicability and effectiveness of machine learning approaches in various domains where scheduling plays a critical role.

Various aspects of the present disclosure are directed to a machine learning scheduler (e.g., prioritization model) that uses a one-shot neural network encoder to sample node priorities. These priorities may be converted into final schedules using list scheduling techniques. In some examples, an end-to-end approach may learn scheduling priorities designed for list scheduling on directed acyclic graphs (DAGs). In some aspects, a topoformer architecture may learn node priorities for list scheduling. The prioritization model may be trained using a reinforce function. The prioritization model may use a Gumbel top-k function to sample multiple schedules by perturbing the generated priorities. Specifically, node priorities may be generated using the Gumbel Top-K function.

In contrast to conventional machine learning schedulers, the prioritization model incorporates a single-shot encoding phase, such that node priorities may be generated in a single-shot. Accordingly, the prioritization model generates node priorities by running the topoformer architecture only once, which enhances scalability for large graphs. By introducing the one-shot neural network encoder and leveraging list scheduling, the prioritization model uses less computational resources while improving performance (e.g., model speed and/or accuracy) in comparison to conventional machine learning schedulers. The prioritization model may schedule a range of scheduling tasks, including both synthetic and real-world scenarios.

In scheduling problems, a DAG G may be represented as a tuple G:=( [symbol] ,ε,δ,ρ,μ) with a set [symbol] of nodes (e.g., vertices) and a set ε of directed edges (e.g., arcs). Each node v∈ [symbol] represents an operation with a parameter δ(v)≥0 representing an operational duration and a parameter ρ(v)≥0 representing resources specified to execute the operation associated with the node v. For a set [symbol] of machine types, each node v∈ [symbol] may be assigned to its own machine type μ(v)∈ [symbol] , where | [symbol] |=1 corresponds to scheduling with homogeneous machines and | [symbol] |>1 corresponds to scheduling with heterogeneous machines. The set E of edges in the DAG G represents computational dependency among nodes. For example, for each node v E V in the scheduling problem, a scheduled start time τ(v) is greater than or equal to zero (τ(v)≥0). Additionally, for a directed edge (v₁,v₂)∈ε, where v₁,v₂∈ [symbol] , a scheduling constraint may be expressed as τ(v₁)+δ(v₁)≤τ(v₂), where a start time of a node v 2 is scheduled after all preceding nodes v₁ are finished, thereby preserving the correct order of operations based on their dependencies in the DAG G. For each type of machine m∈ [symbol] , a maximum resource limit λ(m) is greater than or equal to zero (λ(m)≥0). Therefore, at any given point of time, a total amount of occupied resources for machines of type m cannot exceed λ(m).

A vectorized notation τ=[τ(v)]_{v∈} [symbol] ∈ [symbol] _{≥0}^{|} [symbol] ^{|} represents the start times of all nodes v in a DAG G. For ease of explanation, the notation τ is simplified. A valid schedule may be defined as a vector τ∈ [symbol] , where the parameter [symbol] represents the set of all valid schedules satisfying both precedence and resource constraints for the given DAG G. The objective of the scheduling problem is to find the optimal schedule τ*:=arg mi [symbol] C(τ;G), where C(τ;G):=ma [symbol] {τ(v)+δ(v)} represents the makespan of schedule r for the DAG G.

As discussed, aspects of the present disclosure are directed to a one-shot neural network scheduler developed for solving DAG scheduling problems. In some examples, a set of DAGs [symbol] may be specified, where the set of DAGs [symbol] :={G₁, G₂, . . . }. As discussed, each DAG Gᵢ may be represented as a tuple (DAG Gᵢ:=( [symbol] ᵢ,εᵢ,δᵢ,ρᵢ, μᵢ)). It is assumed that one or more devices are equipped with one or more processors specified for executing the operations associated with the DAGs.

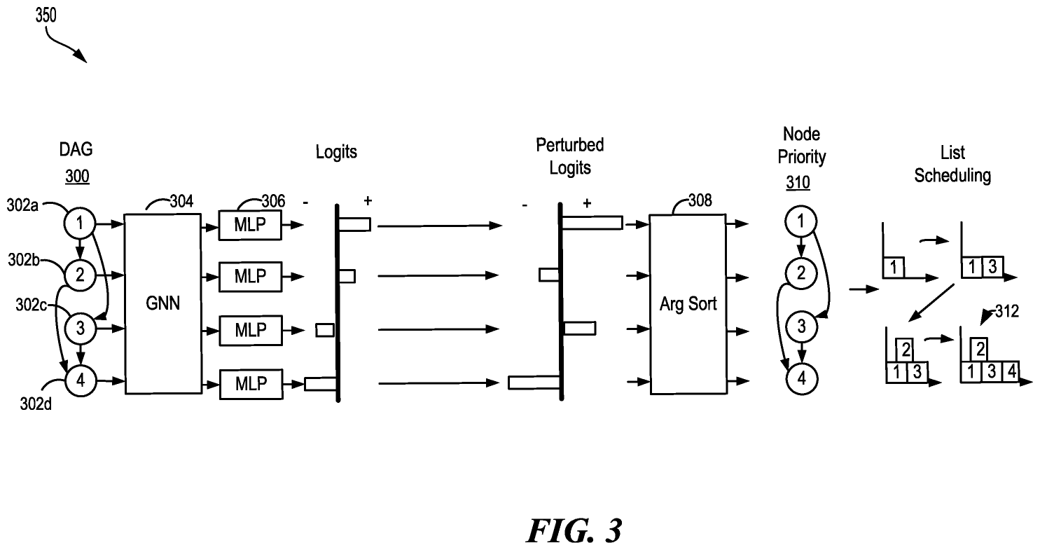

FIG. 3 is a diagram illustrating an example of a scheduling model 350 associated with scheduling operations associated with a DAG 300, in accordance with various aspects of the present disclosure. In the example of FIG. 3, the scheduling model 350 may be executed by the SOC 100 and/or one or more processors associated with the SOC 100, such as (but not limited to) the NPU 108, the CPU 102, the DSP 106, and/or the GPU 104, as described with reference to FIG. 1.

As shown in the example of FIG. 3, the DAG 300 includes a group of nodes 302a, 302b, 302c, 302d (labeled nodes 1-4). Each node 302a, 302b, 302c, 302d may be associated with a respective operation of a task. The task may be an example of a task performed by, or associated with, an artificial neural network. The task may be executed by one or more devices, such as one or more processors. In the example of FIG. 3, each node 302b, 302c, 302d after an initial node 302a may be dependent on an output of one or more previous nodes 302a, 302b, 302c, 302d. The dependencies are illustrated via the arrows connecting the nodes 302a, 302b, 302c, 302d. For example, a third node 302c is dependent on an output of a first node 302a, such that an operation associated with the third node 302c cannot start until an operation associated with the first node 302a is completed.

Conventional scheduling functions are directed to training a parameterized schedule generator π_{θ}(τ|G) (with the neural network parameter θ) that minimizes the average makespan of a set of DAGs [symbol] , where the parameter r represents a schedule (e.g., respective start times) for a set of nodes associated with a DAG G. Conventional schedulers are sequential decision-making models that use multi-shot neural network processing. In contrast, aspects of the present disclosure are directed to a one-shot (e.g., single-shot) neural scheduler 304 (shown as GNN_{θ}_{₁}). The scheduler 304 is an example of a graph neural network (GNN) encoder, which is a type of topoformer. The GNN encoder may be represented as GNN_{θ}_{₁}(G)∈( [symbol] ^{h})^{|} [symbol] ^{|}, where a parameter h represents a dimension of output embeddings for each node 302a, 302b, 302c, 302d, and a parameter θ₁ represents a neural network parameter of the encoder.

As shown in the example of FIG. 3, a multi-layer perceptron (MLP) 306 (shown as MLP θ₂), where MLP θ₂: [symbol] ^{h}→ [symbol] may convert the node embeddings output of the scheduler 304 into logits over the nodes, representing unnormalized probabilities of each node being chosen. The higher the logits for a particular node, the more likely it is to be selected or prioritized in the scheduling process. A combined set of parameters θ for the scheduling model 350 includes parameters associated with the scheduler 304 (GNN_{θ}_{₁}) and parameters associated with the MLP 306 (MLP θ₂) (e.g., θ:=(θ₁,θ₂)). The scheduling model 350 may be applied to a set of DAGs G∈ [symbol] ={G₁, G₂, . . . }. For each graph Gᵢ, the scheduler 304 and the MLP 306 process the node embeddings to obtain the corresponding logits, which then guide the scheduling decisions for each node in the graph Gᵢ. The function may be represented as:

logits_{θ}(v;G):=MLP_{θ}_{₂}([GNN_{θ}_{₁}(G)]ᵥ)∈ [symbol] , v∈ [symbol] . (1)

Equation 1 represents the computation of logits for a specific node v in the graph G using the given model parameters θ:=(θ₁,θ₂). The function GNN_{θ}_{₁}(G) represents an application of the GNN encoder (e.g., scheduler 304) on the graph G to produce a set of node embeddings ( [symbol] ^{h}) for all nodes in the graph G. The function [GNN_{θ}_{₁}(G)]ᵥ extracts the node embeddings corresponding to a node v from the set of node embeddings. The function MLP_{θ}_{₂} ([GNN_{θ}_{₁}(G)]ᵥ) applies the MLP on the node embeddings corresponding to the node v to generate a positive or negative scalar value associated with the respective logits for the node v. As discussed, the respective logits determine a priority of the node v in the scheduling process.

In conventional scheduling models, logits associated with schedulable nodes are considered at each decoding step, and nodes are sequentially sampled from those schedulable nodes during the decoding process. In contrast, aspects of the present disclosure sample node priorities only once at the beginning of the decoding process. In some examples, independent and identically distributed (i.i.d.) standard Gumbel variables Z(v)∈ [symbol] (shown as Std. Gumbel in FIG. 3) are used for each node v∈ [symbol] to generate perturbed logits for the respective node v. The Gumbel variables are drawn from a specific probability distribution known as the Gumbel distribution. This distribution is characterized by its property of introducing randomness, making it suitable for generating perturbations in the node priorities during the decoding process That is, these Gumbel variables introduce randomness to the sampling process.

As shown in the example of FIG. 3, the perturbed logits may be sorted by a sorting function 308, such as arg sort, to generate a sequence of prioritized nodes 310 \vec{V}. In the example of FIG. 3, the nodes may be prioritized in the following order: first node 302a, third node 302c, second node 302b, and fourth node 302d. The sequence of prioritized node 310 \vec{V} may be obtained as follows:

$$\vec{V} := [ {V}_{1} , {V}_{2} , … , {V}_{\vert 𝒱 \vert} ] := {arg sort}_{v ∈ 𝒱} \{ {\underbrace{{logits}_{θ} ( v ; G ) + Z ( v )}}_{perturbed logits} \} . \qquad ( 2 )$$

In Equation 2, the parameter \vec{V} represents the sequence of prioritized nodes 310 [V₁, V₂, . . . , V_{|V|}] obtained by sorting the nodes, in accordance with a sorting function (arg sort), based on respective perturbed logits. The perturbed logits introduce randomness to the node priorities. Higher perturbed logits for a node in the sequence of prioritized nodes 310 \vec{V} indicate a higher probability of being selected, while lower perturbed logits imply lower priority. Nodes may be sampled for the scheduling process based on the sequence of prioritized nodes 310 \vec{V}. As discussed, this sampling is performed only once at the start of decoding, thereby reducing resource use for generating the schedule.

Additionally, in Equation 2, the left-hand side (LHS) (\vec{V}:=[V₁, V₂, . . . , V_{|V|}]) represents a random sequence due to the randomness introduced by the Gumbel variables Z. The arg sort operation is applied to this random sequence, sorting the nodes based on decreasing values of the perturbed logits. As a result, V₁>V₂> . . . >V_{|V|} denotes the sequence of node priorities, with higher-priority nodes listed first.

Based on a Gumbel-Top-k operation, a mapping from the sequence of prioritized nodes 310 \vec{V} to the node priorities V₁>V₂> . . . >V_{|V|} may be equivalent to sampling nodes without replacement, where nodes sampled earlier are considered to be higher-priority. Thus, nodes in the sampled sequence are treated as if they were drawn in order of decreasing priorities. This stochasticity introduced by the Gumbel-Top-k operation allows for efficient sampling of nodes while maintaining the essential characteristics of node priorities.

The Gumbel-Top-k operation provides a tractable distribution of the sequence of prioritized nodes 310 \vec{V}. The tractable distribution may be beneficial when optimizing the scheduling model 350, as the tractable distribution allows for computing gradients when training the scheduling model 350 to generate schedules based on the sampled node priorities.

In some examples, list scheduling may generate a schedule 312 τ based on a scheduling function (ListScheduling( )). The schedule 312 τ satisfies both the precedence constraints (e.g., nodes are scheduled after their predecessors finish) and the resource constraints. In such examples, the schedule 312 τ may be generated as follows:

τ=ListScheduling(\vec{V};G)∈ [symbol] _{≥0}^{|} [symbol] ^{|}. (3)

In Equation 3, for each node Vᵢ in the sequence \vec{V}, the function finds the earliest available time slot to schedule node Vᵢ by checking the finish times of its predecessors in the graph G. The start time of node Vᵢ may be set to the earliest available time slot. After iterating through all nodes in the sequence \vec{V}, and scheduling the nodes based on their priorities and dependencies, the resulting schedule 312 τ will be a valid schedule with start times for each node. The schedule 312 τ may be represented as a vector of start times τ∈ [symbol] _{≥0}^{|} [symbol] ^{|} where [symbol] _{≥0} denotes a set of non-negative real numbers.

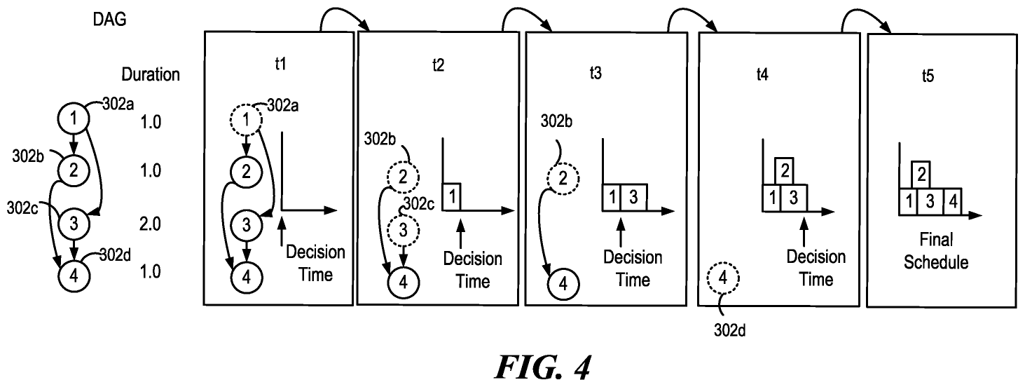

FIG. 4 is a timing diagram illustrating an example of scheduling nodes in a DAG 300, in accordance with various aspects of the present disclosure. In the example of FIG. 4, for ease of explanation, two devices D1 and D2 are specified for executing the operations associated with a set of nodes 302a, 302b, 302c, 302d in the DAG 300. Each node 302a, 302b, 302c, 302d may be associated with a duration (e.g., run time). The nodes 302a, 302b, 302c, 302d may be prioritized based on the sorting function 308 as described with respect to FIG. 3. Although not shown in the example of FIG. 4, the nodes 302a, 302b, 302c, 302d may be prioritized in the following order: first node 302a, third node 302c, second node 302b, and fourth node 302d.

In the example of FIG. 4, at time t1, a scheduling function finds one or more ready nodes that can be scheduled at the current decision time. A ready node is a node whose predecessors have finished. At time t1, the first node 302a is the only ready node in the DAG 300. At time t2, the scheduling function schedules the ready node sequentially at the current decision time by following the order of node priority until either all of the ready nodes are scheduled, or further nodes cannot be scheduled due to resource constraints. As shown in the example of FIG. 4, at time t2, a first operation (1) associated with the first node 302a is scheduled to execute on a first device (D1). Additionally, after scheduling the first node 302a, at time t2, the decision time is moved to the earliest finish time over all scheduled nodes that have not finished at the current decision time. For example, at time t2, the decision time is moved to the end of the first operation (1) associated with the first node 302a. The process of time t1 and t2 is repeated until all nodes are scheduled.

As shown in the example of FIG. 4, after scheduling the first operation (1) at time t2, the ready nodes are the second node 302b and the third node 302c, because each of the second and third nodes 302b and 302c are dependent on the first node 302a. Because the third node 302c has a higher priority than the second node 302b, at time t3, a third operation (3) associated with the third node 302c is scheduled after the first operation (1) on the first device (D1). Additionally, at time t3, the second node 302b is the remaining ready node. Therefore, at time t4, a second operation (2) is scheduled for a second device (D2). Furthermore, at time t4, the fourth node 302d is the remaining ready node. Thus, at time t5, a fourth operation (4) associated with the fourth node 302d is scheduled on the first device (D1).

As discussed with respect to FIG. 3, a Gumbel-Top-k operation may provide a tractable distribution of the sequence of prioritized nodes 310 \vec{V}. A Gumbel-Max operation may sample from categorical distributions when logits (e.g., parameters) characterizing the distributions are tractable. The Gumbel-Max operation uses a random vector Z∈ [symbol] where each elements Z(y), y∈ [symbol] is sampled from an i.i.d. standard Gumbel distribution. An arg max function may randomly generate a category using the Gumbel-Max operation:

$${arg max}_{y ∈ 𝒴} \{ logits ( y ) + Z ( y ) \} ∼ Pr \{ Y = y \} . \qquad ( 4 )$$

In Equation 4, the parameter Y represents a random variable defined over a set [symbol] of finite categories, with the distribution given by the softmax over logits(y)∈ [symbol] for each category y∈ [symbol] . The softmax assigns unnormalized log-probabilities to each category, and the probability of the random variable Y taking on a value of a category y is given by:

$$Pr \{ Y = y \} = \frac{exp ( logits ( y ) )}{{Σ}_{{y}^{′} ∈ 𝒴} exp ( logits ( {y}^{′} ) )} . \qquad ( 5 )$$

In some examples, the Gumbel-Max operation may sample k categories without replacement. Such examples may be referred to as the Gumbel-Top-k operation. In such examples, the arg top^{(k)} operator may take a real vector over the set [symbol] as input and output a sequence of k elements from the set [symbol] that correspond to the k largest values. The sequence of elements should be ordered by the corresponding decreasing input values. When k=| [symbol] |, arg top^{(k)} becomes arg sort in decreasing values. The Gumbel-Top-k operation generates a random sequence of k elements from the random variable Y as follows:

$$[ {Y}_{1} , {Y}_{2} , … , {Y}_{k} ] := {{arg top}_{y ∈ 𝒴}}^{( k )} \{ logit s ( y ) + Z ( y ) \} . \qquad ( 6 )$$

In Equation 6, the element Z is sampled once before applying arg top^{(k)}. The distribution of the random sequence [Y₁, Y₂, . . . , Yₖ] may be described as:

$$P r \{ [ {Y}_{1} , {Y}_{2} , … , {Y}_{k} ] = [ {y}_{1} , {y}_{2} , … , {y}_{k} ] \} = {Π}_{i = 1}^{k} \frac{exp ( logit s ( {y}_{i} ) )}{{Σ}_{{y}^{′} ∈ 𝒴 \backslash \{ {y}_{1} , … , {y}_{i - 1} \}} exp ( logit s ( {y}^{′} ) )} . \qquad ( 7 )$$

In Equation 7, the expression Pr{[Y₁, Y₂, . . . , Yₖ]=[y₁, y₂, . . . , yₖ]} represents the probability that a random sequence of k elements from the set [symbol] matches the specific sequence [y₁, y₂, . . . , yₖ]. The variables Y₁, Y₂, . . . , Yₖ are random variables representing the k sampled elements from the set [symbol] . The probability of this specific sequence occurrence can be broken down into a product of individual probabilities, each representing the likelihood of selecting each element yᵢ at the i-th position in the sequence.

In some conventional systems, a learning-to-schedule function aims to find a parameterized schedule generator π_{θ}(τ|G) (with the neural network parameter θ) that minimizes the average makespan of a set of graphs [symbol] :

$${arg min}_{θ} {𝔼}_{G \sim 𝒢} {𝔼}_{τ \sim {π}_{θ} ( \cdot \vert G )} [ C ( τ ; G ) ] . \qquad ( 8 )$$

In accordance with the scheduling model 350 described with reference to FIG. 3, Equation 8 may be rewritten as follows:

$${arg min}_{θ} {𝔼}_{G \sim 𝒢} {𝔼}_{\vec{V} \sim {π}_{θ} ( \cdot \vert G )} {C}_{L S} ( \vec{V} ; G ) . \qquad ( 9 )$$

In Equation 9, the function C_{LS}(\vec{V};G) represents a makespan of list scheduling for given node priorities \vec{V}=[V₁, . . . , V_{|} [symbol] _{|}] and the graph G, where C_{LS}(\vec{V};G)=C(ListScheduling (\vec{V};G);G). Additionally, π_{θ}(⋅|G) represents the probability distribution of sampling node priorities for the graph G. The tractable form of the probability distribution π_{θ}(⋅|G) may be obtained from the Gumbel-Top-k operation, as follows:

$${π}_{θ} ( [ {v}_{1} , … , {v}_{\vert 𝒱 \vert} ] \vert G ) := P {r}_{θ} \{ \vec{V} = [ {v}_{1} , … , {v}_{\vert 𝒱 \vert} ] \vert G \} = {\prod }_{i = 1}^{\vert 𝒱 \vert} \frac{exp ( {logits}_{θ} ( {v}_{i} ; G ) )}{{Σ}_{v ∈ 𝒱 ∖ \{ {v}_{1} , … , {v}_{i - 1} \}} exp ( {logits}_{θ} ( v ; G ) )} . \qquad ( 10 )$$

In accordance with obtaining a tractable form of the probability distribution π_{θ}(⋅|G), Equation 9 may be rewritten as follows with a learning rate α>0:

θ←θ−α [symbol] [symbol] _{\vec{V}˜π}_{_{θ}}_{(⋅|G)}[∇_{θ} log π_{θ}(\vec{V}|G)C_{LS}(\vec{V};G)]. (11)

In some examples, the scheduling model 350 described with reference to FIG. 3 may be trained to optimize the neural network parameters θ to improve the performance of scheduling operations associated with nodes of a directed acyclic graph (DAG). The scheduling function uses a one-shot priority sampling mechanism to generate node priorities for scheduling. During training, the inputs to the scheduling model 350 may include a set [symbol] :={G₁, G₂, . . . } of training graphs, a node priority sampler π_{θ} that generates node priorities for scheduling based on the current neural network parameters θ, a learning rate α>0 for gradient descent optimization, and a regularization coefficient c_{logits}>0 for logit norm regularization.

The training function performs as follows. For each epoch in the training process, the training function performs the following for each graph G in the set of DAGs [symbol] . First, the training function samples a batch of node priorities \vec{V}⁽¹⁾, \vec{V}⁽²⁾, . . . \vec{V}^{(N)} from the node priority sampler π_{θ} given the input graph G. Then, the sampled node priorities are converted into valid schedules using list scheduling C_{LS}(⋅). A makespan may then be evaluated for each sampled schedule (C_{LS}(\vec{V}⁽¹⁾;G), . . . , C_{LS}(\vec{V}^{(N)};G)). The makespan for each schedule may be standardized based on the following equation:

$${\overline{C}}_{n} = \overline{C} ( \vec{V} ; {\vec{V}}^{( 1 )} , … , {\vec{V}}^{( N )} , G ) := \frac{{C}_{LS} ( \vec{V} ; G ) - {mean}_{n = 1 , … , N} [ {C}_{LS} ( {\vec{V}}^{( n )} ; G )}{max \{ {std}_{n = 1 , … , N} [ {C}_{L S} ( {\vec{V}}^{( n )} ; G ) ] , ϵ \}} . \qquad ( 12 )$$

A reinforce gradient g_{REINFORCE} may update the neural network parameters θ. The reinforce gradient g_{REINFORCE} may be an average gradient of the log probabilities of the sampled schedules (\vec{V}⁽¹⁾;G) weighted by their standardized makespans

$${\overline{C}}_{n} ( e . g . , \frac{1}{N} {\sum }_{n = 1}^{N} {∇}_{θ} log {π}_{θ} ( {\vec{V}}^{( N )} ; G ) {\overline{C}}_{n} ) .$$

The reinforce gradient g_{REINFORCE} is a reinforcement learning function for optimizing parameters of a policy in a reinforcement learning setting. One objective of reinforce gradient g_{REINFORCE} is to find the policy parameters that maximize the expected reward or return over time. After determining the reinforce gradient g_{REINFORCE}, the training determines a logit norm gradient g_{logits} based on the following equation:

$${L}_{logits} ( θ ; G ) := \frac{1}{\vert 𝒱 \vert} {\sum }_{v ∈ 𝒱} {{logits}_{θ} ( v ; G )}^{2} . \qquad ( 13 )$$

The logit norm gradient g_{logits} regularizes the norm of logits to mitigate numerical errors due to the unbounded logits. The regularization loss L_{logits}(θ;G) may be multiplied by a constant c_{logits}>0 to balance between a REINFORCE loss and regularization. Finally, the neural network parameters θ may be updated using gradient descent: θ←θ−α(g_{REINFORCE}+g_{logits}). The trained node priority sampler π_{θ} with optimized neural network parameters θ can be used for scheduling on DAGs

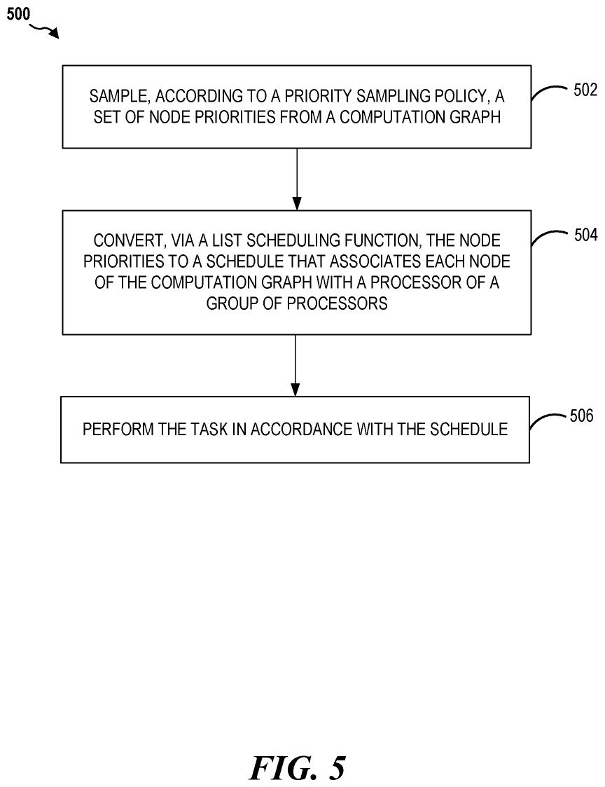

FIG. 5 is a flow diagram illustrating an example of a process 500 for scheduling operations associated with a DAG, in accordance with various aspects of the present disclosure. The process 500 may be performed by the scheduling model 350, as described with reference to FIG. 3, or the SOC 100 and/or one or more processors associated with the SOC 100, such as (but not limited to) the NPU 108, the CPU 102, the DSP 106, and/or the GPU 104, as described with reference to FIG. 1.

As shown in the example of FIG. 5, the process 500 begins at block 502 by sampling, according to a priority sampling policy, a set of node priorities from a computation graph. Each node priority of the set of node priorities may be associated with a respective node of the computation graph. Additionally, each node of the computation graph represents an operation of a task. In some examples, the task may be performed by an artificial neural network that is associated with one or more devices. That is, the one or more devices may execute the operations associated with the task. Each of the one of more devices may include one or more processing units (e.g., processors) and/or one or more memories. At block 504, the process 500 converts, via a list scheduling function, the node priorities to a schedule that associates each node of the computation graph with a processor of a group of processors of the one or more devices associated with the artificial neural network. The schedule is associated with a makespan. At block 506, the process 500 performs the task in accordance with the schedule.

Implementation examples are described in the following numbered clauses:
Clause 1. A processor-implemented method comprising: sampling, according to a priority sampling policy, a set of node priorities from a computation graph, each node priority of the set of node priorities associated with a respective node on the computation graph, each node representing an operation of a task performed by an artificial neural network; converting, via a list scheduling function, the node priorities to a schedule that associates each node of the computation graph with a processor of a group of processors of a device associated with the artificial neural network, the schedule associated with a makespan; and performing the task in accordance with the schedule.
Clause 2. The processor-implemented method of Clause 1, further comprising generating a policy parameter associated with the priority sampling policy via reinforcement learning.
Clause 3. The processor-implemented method of any one of Clauses 1-2, wherein the priority sampling policy samples the set of node priorities according to a Gumbel Top-K function.
Clause 4. The processor-implemented method of Clause 3, further comprising: generating, for each node of the computation graph, a logit indicating a probability distribution for a priority of the node; and adding Gumbel noise to a logit representation of each node.
Clause 5. The processor-implemented method of Clause 4, wherein the set of node priorities are sampled from the logit representation of each node with added Gumbel noise.
Clause 6. The processor-implemented method of any one of Clauses 1-5, wherein the makespan is a maximum across an end time of each operation on the processor associated with each node.
Clause 7. The processor-implemented method of any one of Clauses 1-6, wherein the task is an inference task performed by the artificial neural network.
Clause 8. The processor-implemented method of any one of Clauses 1-7, wherein the task is a hierarchical task.
Clause 9. An apparatus comprising one or more processors, one or more memories coupled with the one or more processors, and instructions stored in the memory and operable, when executed by the one or more processors to cause the apparatus to perform any one of Clauses 1 through 8.
Clause 10. An apparatus comprising at least one means for performing any one of Clauses 1 through 8.
Clause 11. A computer program comprising code for causing an apparatus to perform any one of Clauses 1 through 8.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
sampling, according to a priority sampling policy, a set of node priorities from a computation graph, each node priority of the set of node priorities associated with a respective node on the computation graph, each node representing an operation of a task performed by an artificial neural network;
converting, via a list scheduling function, the node priorities to a schedule that associates each node of the computation graph with a processor of a group of processors of a device associated with the artificial neural network, the schedule associated with a makespan; and
performing the task in accordance with the schedule.

2. The processor-implemented method of claim 1, further comprising generating a policy parameter associated with the priority sampling policy via reinforcement learning.

3. The processor-implemented method of claim 1, wherein the priority sampling policy samples the set of node priorities according to a Gumbel Top-K function.

4. The processor-implemented method of claim 3, further comprising:
generating, for each node of the computation graph, a logit indicating a probability distribution for a priority of the node; and
adding Gumbel noise to a logit representation of each node.

5. The processor-implemented method of claim 4, wherein the set of node priorities are sampled from the logit representation of each node with added Gumbel noise.

6. The processor-implemented method of claim 1, wherein the makespan is a maximum across an end time of each operation on the processor associated with each node.

7. The processor-implemented method of claim 1, wherein the task is an inference task performed by the artificial neural network.

8. The processor-implemented method of claim 1, wherein the task is a hierarchical task.

9. An apparatus comprising:
means for sampling, according to a priority sampling policy, a set of node priorities from a computation graph, each node priority of the set of node priorities associated with a respective node on the computation graph, each node representing an operation of a task performed by an artificial neural network;
means for converting, via a list scheduling function, the node priorities to a schedule that associates each node of the computation graph with a processor of a group of processors of a device associated with the artificial neural network, the schedule associated with a makespan; and
means for performing the task in accordance with the schedule.

10. The apparatus of claim 9, further comprising means for generating a policy parameter associated with the priority sampling policy via reinforcement learning.

11. The apparatus of claim 9, wherein the priority sampling policy samples the set of node priorities according to a Gumbel Top-K function.

12. The apparatus of claim 11, further comprising:
means for generating, for each node of the computation graph, a logit indicating a probability distribution for a priority of the node; and
means for adding Gumbel noise to a logit representation of each node.

13. The apparatus of claim 12, wherein the set of node priorities are sampled from the logit representation of each node with added Gumbel noise.

14. The apparatus of claim 9, wherein the makespan is a maximum across an end time of each operation on the processor associated with each node.

15. The apparatus of claim 9, wherein the task is an inference task performed by the artificial neural network.

16. The apparatus of claim 9, wherein the task is a hierarchical task.

17. An apparatus comprising:
one or more processors; and
one or more memories coupled with the processor and storing instructions operable, when executed by the one or more processors, to cause the apparatus to:
sample, according to a priority sampling policy, a set of node priorities from a computation graph, each node priority of the set of node priorities associated with a respective node on the computation graph, each node representing an operation of a task performed by an artificial neural network;
convert, via a list scheduling function, the node priorities to a schedule that associates each node of the computation graph with a processor of a group of processors of a device associated with the artificial neural network, the schedule associated with a makespan; and
perform the task in accordance with the schedule.

18. The apparatus of claim 17, wherein execution of the instructions further causes the apparatus to generate a policy parameter associated with the priority sampling policy via reinforcement learning.

19. The apparatus of claim 17, wherein the priority sampling policy samples the set of node priorities according to a Gumbel Top-K function.

20. The apparatus of claim 19, wherein execution of the instructions further causes the apparatus to:
generate, for each node of the computation graph, a logit indicating a probability distribution for a priority of the node; and
add Gumbel noise to a logit representation of each node.

21. The apparatus of claim 20, wherein the set of node priorities are sampled from the logit representation of each node with added Gumbel noise.

22. The apparatus of claim 17, wherein the makespan is a maximum across an end time of each operation on the processor associated with each node.

23. The apparatus of claim 17, wherein the task is an inference task performed by the artificial neural network.

24. The apparatus of claim 17, wherein the task is a hierarchical task.

25. A non-transitory computer-readable medium having program code recorded thereon, the program code executed by one or more processors and comprising:
program code to sample, according to a priority sampling policy, a set of node priorities from a computation graph, each node priority of the set of node priorities associated with a respective node on the computation graph, each node representing an operation of a task performed by an artificial neural network;
program code to convert, via a list scheduling function, the node priorities to a schedule that associates each node of the computation graph with a processor of a group of processors of a device associated with the artificial neural network, the schedule associated with a makespan; and
program code to perform the task in accordance with the schedule.

26. The non-transitory computer-readable medium of claim 25, wherein the program code further comprises program code to generate a policy parameter associated with the priority sampling policy via reinforcement learning.

27. The non-transitory computer-readable medium of claim 25, wherein the priority sampling policy samples the set of node priorities according to a Gumbel Top-K function.

28. The non-transitory computer-readable medium of claim 27, wherein the program code further comprises:
program code to generate, for each node of the computation graph, a logit indicating a probability distribution for a priority of the node; and
program code to add Gumbel noise to a logit representation of each node.

29. The non-transitory computer-readable medium of claim 28, wherein the set of node priorities are sampled from the logit representation of each node with added Gumbel noise.

30. The non-transitory computer-readable medium of claim 25, wherein the makespan is a maximum across an end time of each operation on the processor associated with each node.
